(19) United States
(12) Patent Application Publication
(10) Pub. No.: US 2014/0313504 A1
(43) Pub. Date: Oct. 23, 2014

(54) PROCEDURE AND DEVICE FOR THE MEASUREMENT OF DYNAMIC LUMINANCE AND RETROREFLECTION OF ROAD MARKINGS AND SIGNALS AND THE OBTENTION OF THE SHAPE, POSITION AND DIMENSIONS OF THE SAME

(71) Applicants: Jose Antonio Gutierrez Mendez, Boecillo (Valladolid) (ES); Alberto Mansilla Gallo, Boecillo (Valladolid) (ES); Jesus Angel Real Cortes, Boecillo (Valladolid) (ES); Diego Ortiz De Lejarazu Machin, Boecillo (Valladolid) (ES)

(72) Inventors: Jose Antonio Gutierrez Mendez, Boecillo (Valladolid) (ES); Alberto Mansilla Gallo, Boecillo (Valladolid) (ES); Jesus Angel Real Cortes, Boecillo (Valladolid) (ES); Diego Ortiz De Lejarazu Machin, Boecillo (Valladolid) (ES)

(73) Assignee: FOUNDAIÓN CIDAUT, Boecillo (Valladolid) (ES)

(21) Appl. No.: 14/007,278

(22) PCT Filed: Nov. 14, 2012
(86) PCT No.: PCT/ES2012/070791

§ 371 Date: May 8, 2014

(51) Int. Cl. G01N 21/55; G01B 11/14; G01B 11/02

(52) U.S. Cl. CPC G01N 21/55; G01B 11/02; G01B 11/14; G01N 2021/551
USPC 356/72; 356/73

(57) ABSTRACT

A dynamic measurement procedure of the luminance and retroreflection of the road markings and signals and obtention of the dimensions of the same from a vehicle that circulates on the road; illuminating the zone of interest; knowing the position of the vehicle; measuring the luminance by means of a light sensor in a single pass, at known distances or intervals; identifying and extracting one or several road markings and signals simultaneously in each measurement of luminance by means of algorithms; referencing the luminance both geometrically and in time, as well as the obtention of the shape, position and dimensions of the same; and the device for carrying out said procedure, which includes a luminous source, a system of global positioning of the vehicle, a light sensor, a camera, a data processor and a data storage device.

### TECHNICAL FIELD OF THE INVENTION

The present disclosure refers to a dynamic procedure for the measurement of luminance and retroreflection of roadway markings and signals that are commonly used on the road for traffic regulation or to inform drivers, and also the obtention of the shape, position and dimensions of the same, and the device for carrying out said procedure.

The procedure is carried out in a dynamic and simultaneous manner on several road markings and signals deployed on highways, roads or streets, either continuous, discontinuous, having arbitrary shapes, signalling elements painted on the road, straight arrows or having a given angle, specific symbols or letters on the surface, etc.

The device is a vehicle that includes an illuminating source, a global vehicle positioning system, a light sensor, a camera, a data processor and a data storage device.

### BACKGROUND OF THE INVENTION

The on site assessment of the essential visibility requirements of road markings and signals, that is, its luminance and retroreflection, both during its application and during its useful life, constitutes the most important problem in relation to the quality control and preservation of horizontal signals and markings.

To this end, means based on portable equipment are traditionally employed, which are expensive, slow and dangerous for the operator, besides being unable to provide an exact overall conclusion of the state of the road signals and markings on an large section.

Mobile measurement equipment is also used to provide the possibility of carrying out a reliable, quick and risk free assessment of the visibility (daytime and nighttime) of road markings along extensive highway networks.

For example, patent document EP1486799, published on 15 Dec. 2004, discloses a procedure and an apparatus for determining the state of road markings by measuring several points of a road marking with an apparatus that comprises an illuminator, a sensor comprising several adjacent detectors, means for controlling the illuminator, and a data processing and control unit.

Said procedure includes measuring the luminance of the interior portion of the road marking at several points and determining the remaining surface area of the road markings based on the measurements. The retroreflection of said road markings is likewise determined on the basis of measurements.

For its part, the patent document US 20070216904, published on 20 Sep. 2007 discloses a procedure for automated determination of retroreflectivity values for reflective surfaces deployed along a road, which repeatedly illuminates a zone along the road that includes at least one reflective surface using a strobing light source

Thus, a plurality of measurements of light intensity is carried out covering a field of vision that includes at least a portion of the zone illuminated by the luminous source.

Afterwards, by employing a data processing system a portion of the light intensity values are that are associated to a reflective surface are identified and the portion of the light intensity values is analysed to determine at least one retroreflectivity value for that reflective surface.

To carry out said procedure, a processor is deployed on top of a vehicle, together with a high intensity luminous source, such as, for example, strobing light lamps, an intensity sensor, a colour camera and a positioning system that sends the information that is registered to a storage system. A preferred embodiment includes a laser for measuring distances and a pair of stereoscopic cameras.

Along the same lines, patent U.S. Pat. No. 6,891,960, published on 10 May 2005, discloses a procedure for classifying sheeting materials on an image frame. In said image frame the colours are determined and an estimated retroreflectivity is established for the same, which is compared to a known minimum. In this way a classification of the retroreflectivity of the sheeting elements is obtained

For this, a zone of the roadway is illuminated with a light and a plurality of values of light intensity is measured. A processor identifies which portion of the values refer to the target to be measured and analyses it. To do so it uses colour images from a plurality of cameras and positioning information from a GPS which, together with the profile of the light from a luminous source, provides accuracy to the determination of the retroreflection values.

The vehicle for carrying out said procedure has a high intensity source of light mounted on it, an intensity sensor, a colour camera, a positioning system, a control system that enables recording any type of roadway marks and a processor. It can also have a mounted laser for measuring distances and two strobe lights.

Patent document U.S. Pat. No. 6,407,674, published on 30 May 2002, refers to an retroreflection measuring apparatus for assessing the integrity of road markings.

The apparatus includes a luminous source, a light sensor and a processing means. The apparatus is mounted on a vehicle in such a way that during use the luminous source illuminates a reflective surface on a highway signal on which the light sensor detects any reflected light while the data signal is received by means of the processing medium, which processes the data to provide information on the reflectivity of said reflecting surface. An indicator directs the driver towards where he has to measure.

Patent document FR 2661248, published on 25 Oct. 1991, discloses a procedure for continuous measurement, with ambient light, of the retroreflection of road markings wherein an incident modulated luminous beam is emitted, while a likewise modulated beam is obtained and received by photoelectric cells, and then sent through a double filter to measure the retroreflection and contrast. Said procedure can be carried out both night and day.

Said document also discloses the device for carrying out the said procedure, which includes a vehicle, a means of emission of the incident luminous beam, a means of reception of the reflected beam, a means of control of the ambient light and the luminous beam, a means for transforming the luminous currents into electric signals such as, for example, photoelectric cells, a means of treating the electrical currents with filtering circuits and a means of modulating the incident beam, such as, for example, a disc with orifices.

The inventions of the cited patents disclose procedures and devices wherein the measurements are carried out on a narrow strip of the road and for a single road marking at a time, which means that several passes are needed to cover all of the lanes of the road, with the resulting multiplication of the image and data analysis, thus requiring operator intervention at some point in time.

The present invention is a procedure and dynamic device for carrying out the solution to the cited drawbacks in the state of the art, exactly as disclosed below.

### DESCRIPTION OF THE INVENTION

In light of the above explanation, the present invention refers to a dynamic procedure of measurement of the luminance and retroreflection of road markings and signals, as well as the obtention of the shape, position and dimensions of the same.

The procedure is implemented from a vehicle that circulates on the road, in other words, in a dynamic manner or while in motion.

The procedure comprises the one or more of the following steps:
a) illumination of a zone of interest with an illuminating source,
b) positioning the vehicle by means of a global positioning system,
c) measurement of the luminance by means of a light sensor of the zone of interest in just one pass, at known distances or intervals in the same instant as that of step b),
d) simultaneous identification and extraction of one or more road markings and signals during each measurement of the luminance acquired in step c) and, in relation to the zone of interest, by means of artificial or manual vision algorithms,
e) referencing of the illumination obtained in step c) according the measurement of step b), both geometrically and in time,
f) measurement of the road markings and signals identified in step d), and referred to in step e), for obtaining the luminance values and the retroreflection coefficient.
g) obtention of the shape, position and dimensions of said road markings and signals identified in step d) and referred to in step 3).

The implementation of the present procedure enables characterising and assessing the values of luminance and retroreflection, as well as obtaining the shape, position and dimensions of several road markings and signals in a simultaneous and dynamic manner, by means of luminance processing means acquired during the disclosed procedure, likewise known as auscultation.

Moreover, the procedure is applicable in environments where the external illumination is not controllable, that is, it is insensible to other illuminations that could be contaminants, such that the auscultations may be carried out during both night and day.

The present invention comprises the device that enables carrying out the disclosed procedure, being the vehicle itself that which includes an illuminating source, a global vehicle positioning system, a light sensor, a camera, a data processor and a data storage device.

### BRIEF DESCRIPTION OF THE DRAWINGS

The present document is complemented with a set of drawings as an example for illustrating the preferred embodiment, and which in no way limits the invention.

FIG. 1 represents an overhead view of a vehicle equipped for carrying out the disclosed procedure circulating in the right lane of a road.

FIG. 2 illustrates a flow block diagram of a process for carrying out the disclosed procedure.

FIG. 3 depicts an illustrative schematic vehicle operating environment in which various aspects of the present disclosure may be implemented.

FIG. 4 depicts an illustrative schematic data operating environment in which various aspects of the present disclosure may be implemented.

FIG. 5 depicts a schematic diagram of an example scene used to carry out the disclosed procedure circulating in a lane of a road.

FIGS. 6A-6E shows images of an example for carrying out the disclosed procedure.

### DETAILED EXPLANATION OF THE PREFERRED EMBODIMENT OF THE INVENTION

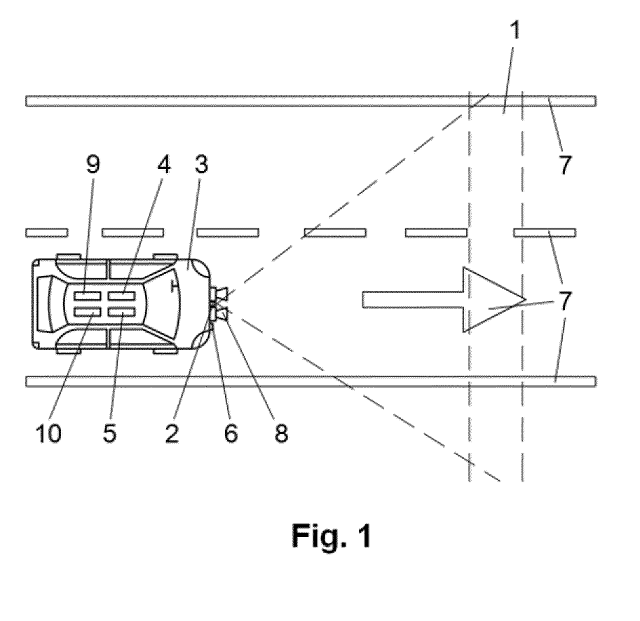

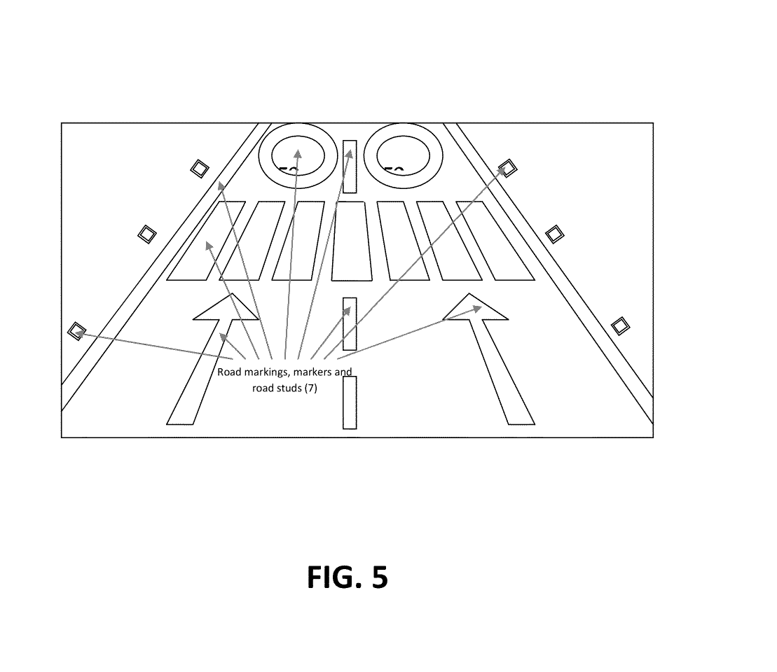

The present disclosure shown in FIGS. 1-6E deals with a dynamic procedure of measurement of the luminance and retroreflection of road markings and signals (7), as well as the obtention of the shape, position and dimensions of the same from a vehicle (3) that circulates on the road.

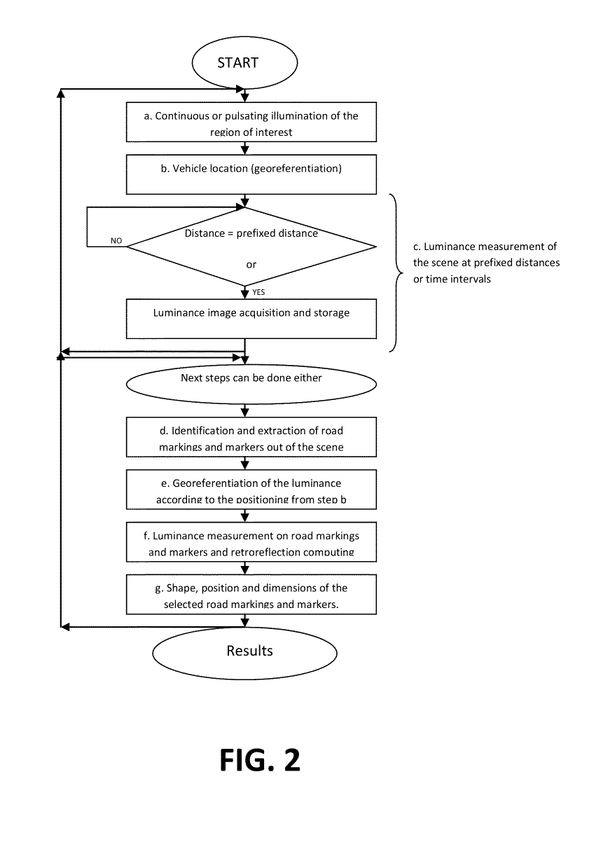

Referring to FIG. 2, the procedure comprises the following steps:
a) illumination of a zone of interest with an illuminating source,
b) positioning the vehicle by means of a global positioning system,
c) measurement of the luminance by means of a light sensor of the zone of interest in just one pass, at known distances or intervals in the same instant as that of step b),
d) simultaneous identification and extraction of one or more road markings and signals during each measurement of the luminance acquired in step c) and, in relation to the zone of interest, by means of artificial or manual vision algorithms,
e) referencing of the illumination obtained in step c) according the measurement of step b), both geometrically and in time,
f) measurement of the road markings and signals identified in step d), and referred to in step e), for obtaining the luminance values and the retroreflection coefficient.
g) obtention of the shape, position and dimensions of said road markings and signals identified in step d) and referred to in step e).

The measurement of the luminance and retroreflection is carried out in a dynamic manner on several road markings and signals (7) simultaneously, as is also the obtention of the shape, position and dimensions of road markings and signals (7) detected during a measurement of luminance acquired through a process of auscultation, together with the data compiled from light sensor (6).

The implementation of the procedure is carried out from a vehicle (3) that circulates on the road. (See FIG. 2)

Referring to FIG. 2, the disclosed embodiment begins by illuminating a zone of interest (1) on the road with a strong illuminating source (2), from which it is possible to determine its light emission in the space, with the possibility of said illuminating source being continuous or pulsating. (Step a)

Said zone of interest (1) is a broad area which comprises, in this embodiment, an angle of vision equal to or larger than that of a user, making reference to the fact that it illuminates a large transversal band of the road, normally the full width of the road or, when it is very large, the majority thereof. For example, on four lane roads, the full width of the road is illuminated, while on five or more lane roads, practically the full width is illuminated.

Next, the position of the vehicle is determined by means of global positioning system (4), such as, for example, a GPS. (Step b)

Subsequently the luminance is measured by means of light sensor (6) at known distances or intervals, at the same instant in which the position of vehicle (3) is determined. (Step c)

Immediately afterwards, one or several road markings or signals (7) are simultaneously identified and extracted from each measurement of luminance in relation to zone of interest (1), by means of artificial or manual vision algorithms.

That is, in the measurements of luminance by means of algorithms of artificial vision (or by manual means), road marking and signals (7) of interest are identified and extracted, with measurements that may contain the same simultaneous measurement of several road markings and signals (7), or of shapes and sizes that differ from each other, for example, having the shape of an arrow, of a traffic signal drawn on the road, different colours, etc.

Next, the measurements and values obtained by cameras (8), sensors (6), at very least the light sensor, are referenced both geometrically and in time.

After road markings and signals (7) are identified and referenced, the luminance and retroreflection values of each one of the road markings and signals are measured over them, such that their shape, position and dimensions are also obtained.

This is possible because said road markings and signals are geo-referenced (for example by means of a GPS or odometer), both geometrically and in time, in the moment that the luminance is measured and the values of sensors (6) are acquired. (Step e)

In one variant, in step c) the measurement of luminance is done through images, which are acquired by means of multiple light sensors (6) that comprise a photosensitive plate, in step d) one or several road markings and signals (7) are identified and extracted from said images and the values obtained in step c), in such a way that the values and dimensions of steps f) and g) are obtained.

Likewise, in step c) values from sensors other than the light sensor can be acquired, for example, GPS, odometer, temperature, humidity and others.

The option exists of determining the luminous emission in the space from the luminous source (2), which facilitates the measurements and calculations.

As another option, the device employed for measuring luminance is a luminance meter. As still another option, the device for measuring the retroreflection is a retroreflector meter.

For the measurement of the luminance and the retroreflection, cameras (8) are calibrated for luminance and the photometry is known of light bulbs (2) which serves as the luminous source from which the spatial distribution of the amount of light that it provides is known.

Both bulbs (2) and cameras (9) are referenced to the same set of coordinates of vehicle (3) and are joined to the chassis thereof.

As an optional way, the coefficient of retroreflection of said road markings and signals (7) are obtained for a specific geometry on the basis of the amount of light provided by luminous source (2), luminance, and the luminance measured on road markings and signals (7), in other words, the luminance collected by cameras (8).

As a preferred manner, luminous source (2) is constantly turned on, although it could be a pulsing source, in order for the procedure to avoid contamination from other luminous sources.

Optionally, as an advantageous way, as has been shown, while vehicle (3) is in movement, the relative position and orientation of said vehicle is measured with respect of the road, by means of a positioning and orienting system relative to road (5), for example, by means of an inertial navigation system which includes, at a minimum, a gyroscope and an accelerometer.

Said in another way, we have a system of measurement which references known fixed parts of vehicle (3) with respect to a system of global coordinates, employing a system of positioning and orientation relative to the road (5).

Thus, in a concrete way the reference of vehicle (3) with respect of the road is obtained by means of range finders located on the vehicle in such a way that information is obtained on the position and orientation of the vehicle with respect of the road, this being a system of positioning and orientation relative to road (5).

Therefore, with the data from the measurement system, the position and orientation of vehicle (3) can be obtained with respect of a system of coordinates on the ground surface (in reference to the road).

In this way at any moment the geometry (position and orientation) is known relative to points on the road and the measurement systems of vehicle (3), which may be influenced by variations, mainly by the movement of the vehicle and irregularities on the road that occur during the procedure, both in the vehicle and on the road.

With knowledge of the orientation of vehicle (3) it is also possible to know the orientation of cameras (9), which are fixed to the chassis of the vehicle. It suffices to know the dimensions of each camera (8) and the distance that exists between it and the system of coordinates of the vehicle.

That is, by knowing the orientation of each camera (8) geometric references are also known of each of the measurements obtained, identifying in each pixel the distances to which they would correspond, supported by the data from global positioning system (4) and from the positioning and orientation system relative to road (5).

The described procedure may be done in an automatic manner given that the steps of the same are carried out by automated instruments, like those found in the market.

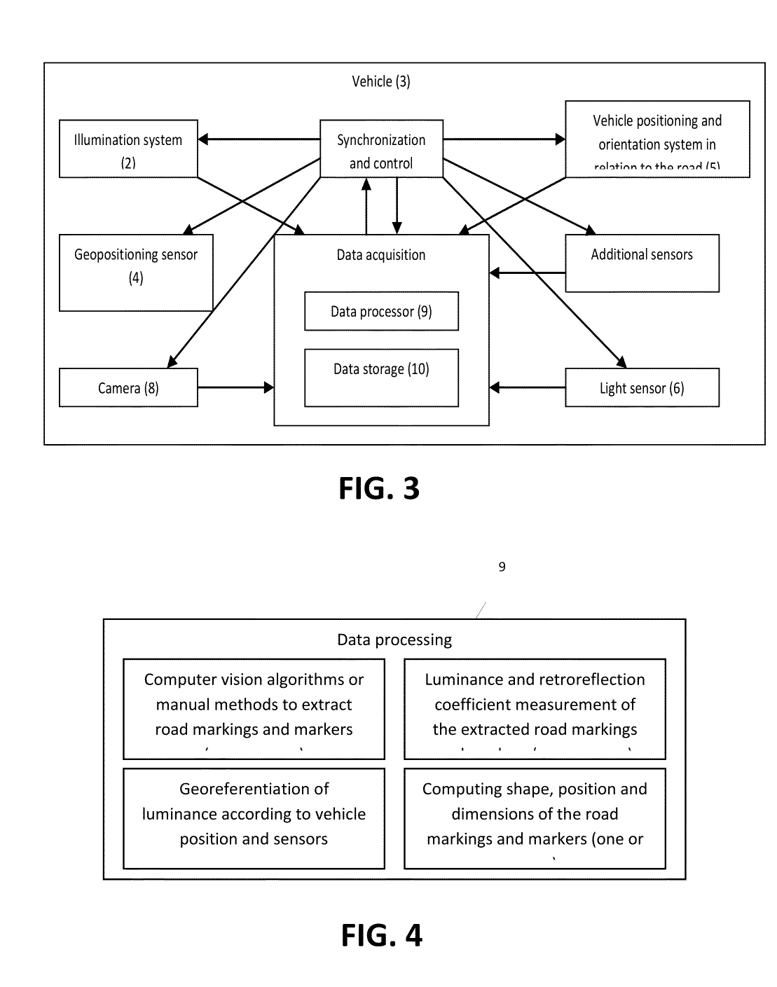

For the measurement of the luminance and retroreflection of the road markings and signal, and the obtention of the dimensions of the same in accordance with the above explanation, a device installed in vehicle (3) is configured, which comprises at least luminous source (2), from which the luminous emission in space may be determined, the global positioning system of vehicle (4), light sensor (6), camera (8), data processor (9) and data storage device (10). (See FIG. 3)

As an option, the device may include a position measurer of the position and orientation of the vehicle with respect to the road (5).

Specifically, GPS, odometer, temperature and humidity sensors may be included.

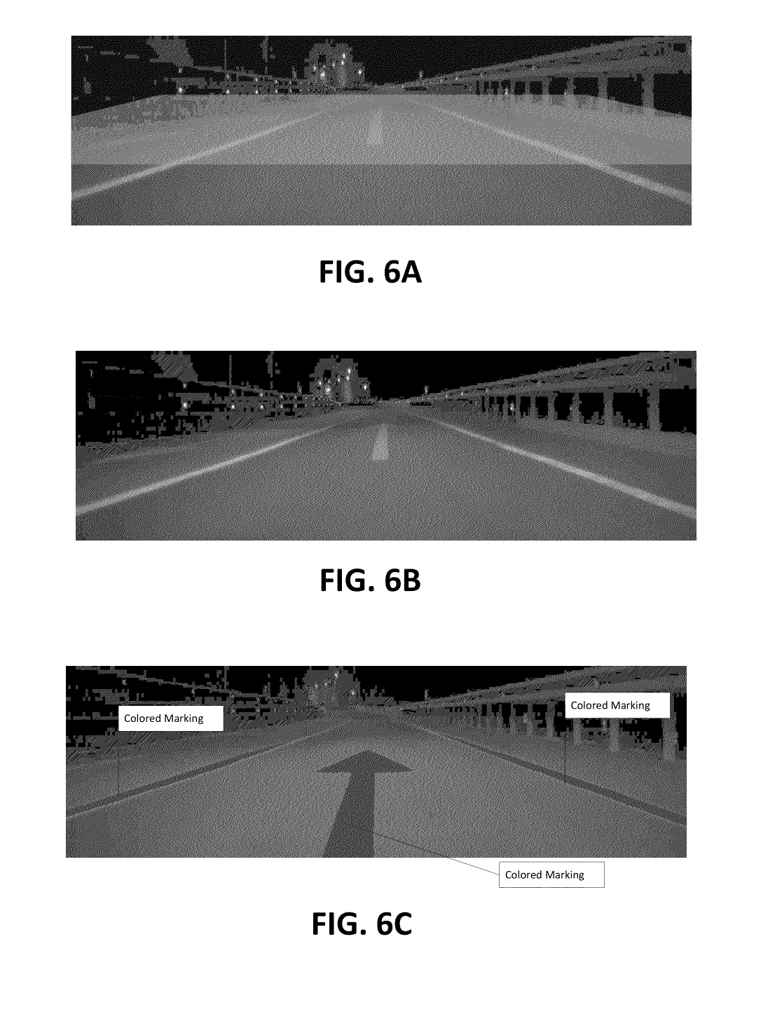

Referring to FIG. 5, a scene such as the one shown in the picture could be used as an example. Different types of reflective markings (7) items can be found on it, such as road studs, markers, and road markings delineating traffic lanes or indicating speed limits, direction of traffic flow, pedestrian crossings, etc.

The FIG. 5 represents one of the pair of images acquired from the region of interest which is being illuminated, which shall be wider than the area captured by the camera. The illumination is switched on and off in a controlled way to capture one of the images with light from the internal source and one without it. Data is collected periodically as the vehicle moves along the road. This can be done either on a regular prefixed distance basis or on a regular time basis, so that all data and images collected can be accurately referenced in time and space.

Once the data have been collected and synchronized with the images taken as discussed above, the processing can be done either in real time or offline. Road surface markings and other reflective items of interest are extracted from the scene for this purpose, using computer vision techniques or manual methods. Then, they are referenced according to the geopositioning data gathered. The final step is to measure the luminance and the coefficient of retroreflection of all the road markings, markers and road studs, determining as well their shape, position and dimensions.

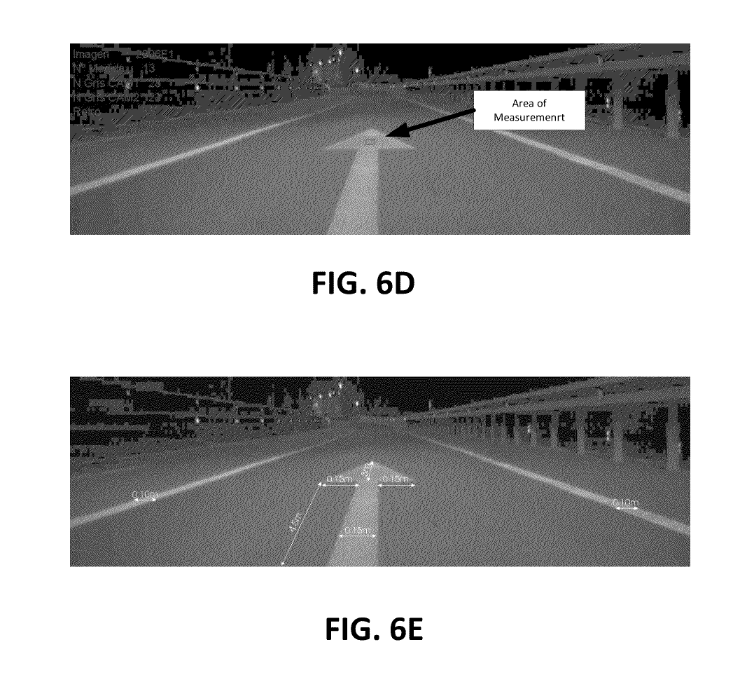

An example for carrying out the disclosed procedure is discussed below with respect to FIGS. 6A-6E. In the process, the scene is illuminated with a chosen illumination type, such as an illuminant (although it may be any other known and characterized such as D65). The area to be illuminated should be larger than the measurement area and with enough uniformity (This is to acquire the spectral and the spatial distribution of light). The illumination area of the device can be wide enough to include more than one lane. Also, the amount of light is such so it's not glaring to not interfere with the rest of the drivers. FIG. 6A is an example (without excluding other forms), showing a possible distribution of the lighting in the scene.

Next the vehicle position is captured with a GPS system (corrected or not with more accurate devices). These coordinates can be obtained in any coordinate system, with or without differential corrections for GPS base station. i.e. 42.335868, −0.400951.

In the example, the luminance images are acquired of the illuminated scene with light sensors (or luminance meters), such as one or more cameras with the necessary configuration of appropriate filters, gains and exposure times to measure luminance in the right range. These images are acquired every 1 meter distance (or other distance setting) as the vehicle moves along the road. This does not exclude the possibility of acquiring the images with a fixed time interval, or even randomly, as long as we know the time periodic of acquisition. FIG. 6B is example of an image acquired in luminance.

In the example, the process extracts from the scene the region of interest for measurements. Computer vision algorithms for extracting the areas and also it can be done manually (or a combination of both). There may be several areas or road markings and symbols in the same scene. From each of this region, the luminance values are calculated. FIG. 6C is an example the red regions are areas that can be measured.

The process references the images obtained with the absolute positions (GPS) of the vehicle, due to the synchronization of the measurements acquired by the sensors in the vehicle. With the data from the absolute positioning system (GPS), the system orientation and position relative to the road, the data from an inertial navigation system and other sensors, we are able to know the distance to the road markings and the symbols from the vehicle components (light sensor, lighting system, etc.). Knowing accurately the distances and the angles of the vehicle elements (light sensor, lighting system, etc.) relatives to each element to be measured, together with the luminance values, and having characterized the illuminant being used, it is possible to calculate the coefficient of retroreflection in the area of measurement. FIG. 6D is an example.

This is repeated for each acquired distance and the process can obtain data tables as shown below:

| DISTANCE | | | |
|---|---|---|---|
| (m) | R (mcd/m2 * lux) | Latitude (degrees) | Longitude (degrees) |
| 0 | 27 | 42.335858 | −0.401108 |
| 1 | 51 | 42.335859 | −0.401096 |
| 2 | 36 | 42.335859 | −0.401084 |
| 3 | 41 | 42.335860 | −0.401072 |
| 4 | 42 | 42.335861 | −0.401060 |
| 5 | 42 | 42.335862 | −0.401048 |
| 6 | 40 | 42.335862 | −0.401036 |
| 7 | 36 | 42.335863 | −0.401023 |
| 8 | 36 | 42.335864 | −0.401011 |
| 9 | 36 | 42.335865 | −0.400999 |
| 10 | 43 | 42.335866 | −0.400987 |
| 11 | 44 | 42.335866 | −0.400975 |
| 12 | 42 | 42.335867 | −0.400963 |
| 13 | 35 | 42.335868 | −0.400951 |

Thus by knowing the geometry of the scene (distances to areas of interest and orientation of the cameras and of the vehicle) the process can obtain the shape, position and dimensions of road markings and markers. FIG. 6E shows an example of the measurements.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. Dynamic procedure of measurement of the luminance and retroreflection of the road markings and signals and obtention of the dimensions of the same from a vehicle that circulates along the road, comprising the following steps:
a. illumination of zone of interest with illuminating source,
b. positioning of vehicle by means of global positioning system,
c. measurement of the luminance by means of light sensor of the zone of interest in a single pass, at distances or intervals known in the same moment as step b),
d. simultaneous identification and extraction of one or more road markings and signals during each measurement of the illumination acquired in step c) and, in relation to the zone of interest, by means of artificial or manual vision algorithms,
e. referencing of the illumination obtained in step c) according the the measurement of step b), both geometrically and in time,
f. measurement over road markings and signals identified in step d), and referred to in step e), of the luminance values and the of retroreflection coefficient.
g. obtention of the shape, position and dimensions of said road markings and signals identified in step d) and referred to in step e).

2. Dynamic measurement and calculation procedure of the luminance and retroreflection of the road markings and signals in accordance with claim 1, wherein in step c) the measurement of luminance is done through images that are acquired by means of multiple light sensors, which comprise a photosensitive plate; in step d) one or several road markings and signals are identified and extracted from said images and values obtained in step c), in such a way that the values and dimensions of steps f) and g) are obtained.

3. Dynamic measurement and calculation procedure of the luminance and retroreflection of the road markings and signals in accordance with claim 1, wherein zone of interest is a broad area, which comprises an angle of vision equal to or greater than that of a user.

4. Dynamic measurement and calculation procedure of the luminance and retroreflection of the road markings and signals in accordance with claim 1, wherein in step c) values are acquired from sensors such as GPS, odometer, temperature and humidity.

5. Dynamic measurement and calculation procedure of the luminance and retroreflection of the road markings and signals in accordance with claim 1, wherein the coefficient of retroreflection of said road markings and signals are obtained for a specific geometry on the basis of the amount of light provided by luminous source (2), and the luminance measured on road markings and signals,

6. Dynamic measurement and calculation procedure of the luminance and retroreflection of the road markings and signals in accordance with claim 1, wherein luminous source is illuminated in a continuous manner.

7. Dynamic measurement and calculation procedure of the luminance and retroreflection of the road markings and signal in accordance with claim 1, wherein luminous source is illuminated in a pulsing mode in order to avoid contamination from other luminous sources.

8. Dynamic measurement and calculation procedure of the luminance and retroreflection of the road markings and signals in accordance with claim 1, wherein the luminous emission in space is known from luminous source.

9. Dynamic measurement and calculation procedure of the luminance and retroreflection of the road markings and signals in accordance with claim 1, wherein the device employed for measuring luminance is a luminance meter.

10. Dynamic measurement and calculation procedure of the luminance and retroreflection of the road markings and signals in accordance with claim 1, wherein the device employed for measuring retroreflection is a retroreflector meter.

11. Dynamic measurement and calculation procedure of the luminance and retroreflection of the road markings and signals in accordance with claim 1, wherein the procedure is automatic.

12. Dynamic measurement and calculation procedure of the luminance and retroreflection of the road markings and signals in accordance with claim 1, wherein the relative position and orientation of the vehicle to the road is measured by means of a positioning and orientation system relative to road, in order to obtain greater accuracy in the measurements.

13. A Device for the measurement of the luminance and retroreflection of the road markings and signals, and the obtention of the dimensions of the same in accordance with a procedure—having the following steps:
a. illumination of zone of interest with illuminating source,
b. positioning of vehicle by means of global positioning system,
c. measurement of the luminance by means of light sensor of the zone of interest in a single pass, at distances or intervals known in the same moment as step b),
d. simultaneous identification and extraction of one or more road markings and signals during each measurement of the illumination acquired in step c) and, in relation to the zone of interest, by means if artificial or manual vision algorithms,
e. referencing of the illumination obtained in step c) according the the measurement of step b), both geometrically and in time,
f. measurement over road markings and signals identified in step d), and referred to in step e), of the luminance values and the of retroreflection coefficient,
g. obtention of the shape, position and dimensions of said road markings and signals identified in step d) and referred to in step e), the device being—installed in a vehicle, comprising, a luminous source, a global positioning system of vehicle, a light sensor, a camera, a data processor and a data storage device.

14. Device in accordance with claim 13, which further comprises a position measurer of the position and orientation of the vehicle with respect of the road.

15. Device in accordance with claim 13, further comprising a GPS unit, an odometer, a temperature and a humidity sensors.
